(19) United States
(12) Patent Application Publication
(10) Pub. No.: US 2009/0322282 A1
(43) Pub. Date: Dec. 31, 2009

(54) CHARGING SYSTEM AND CHARGING APPARATUS THEREOF

(75) Inventor: YUNG-HUNG CHU, Tu-Cheng (TW)

Correspondence Address: PCE INDUSTRY, INC.;ATT. Steven Reiss, 288 SOUTH MAYO AVENUE, CITY OF INDUSTRY, CA, 91789, US

(73) Assignee: HON HAI PRECISION INDUSTRY CO., LTD., Tu-Cheng (TW)

(21) Appl. No.: 12/488,520

(22) Filed: Jun. 20, 2009

(30) Foreign Application Priority Data
Jun. 26, 2008 (CN) 200810302349.5

(51) Int. Cl. H02J 7/02

(52) U.S. Cl. 320/109

(57) ABSTRACT

A charging system includes a robot and a charging apparatus for charging the robot. The robot includes a casing and at least one power receiving terminal. The casing defines at least one slot receiving the at least one power receiving terminal. The charging apparatus includes at least one deformable power supply terminal. The at least one power receiving terminal is pressed to be deformed by the casing of the robot.

### BACKGROUND

1. Technical Field

The present disclosure relates to charging systems, and more particularly to a charging system for a robot.

2. Description of Related Art

Conventional robots generally utilize rechargeable batteries as power sources. When the voltage of a rechargeable battery is lower than a predetermined value, the battery needs to be recharged via a charging apparatus. A robot usually includes an infrared sensor for communicating with the charging apparatus, in order to guide the robot to move toward the charging apparatus. When the robot approaches the charging apparatus, care must be taken to plug the connector on the robot to the connector on the charging apparatus or the connector pins may be damaged or the charging connector may even scrape the robot.

Therefore, a need exits for providing a charging apparatus that reduces damages to the connector and the robot.

### BRIEF DESCRIPTION OF THE DRAWINGS

FIG. 1 is an isometric view of a charging system, comprising a robot and a charging apparatus, in accordance with an exemplary embodiment.

FIG. 2 is an isometric view of the charging system of FIG. 1, with the robot docked in the charging apparatus.

### DETAILED DESCRIPTION

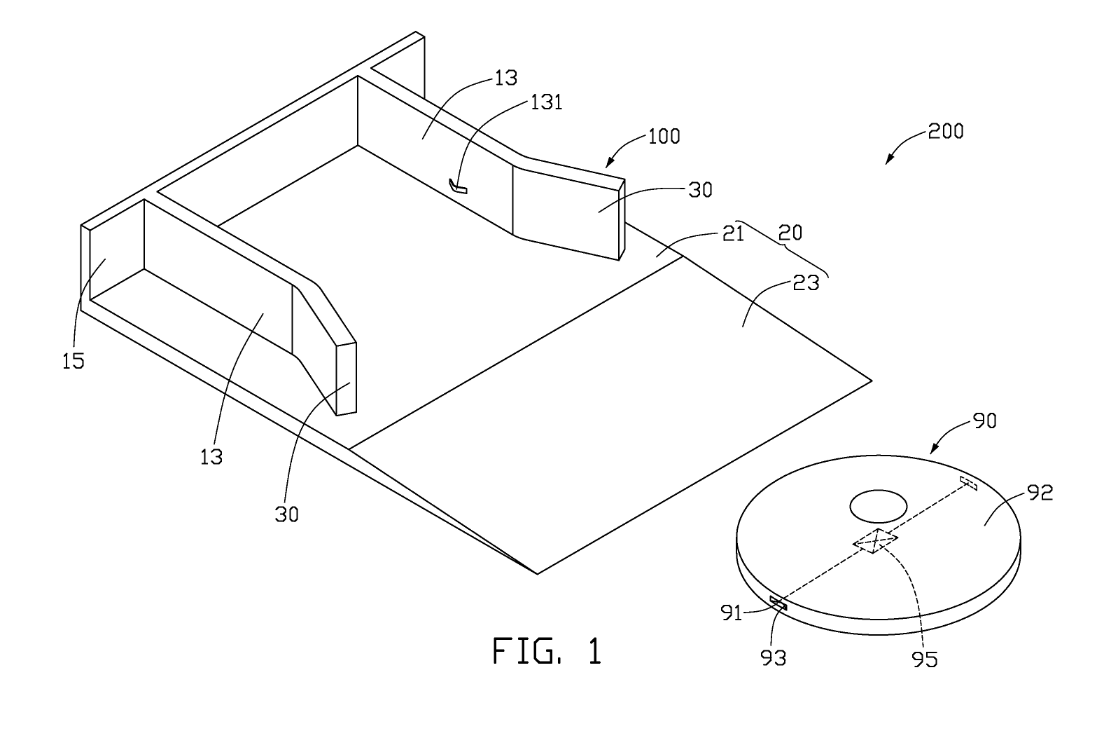

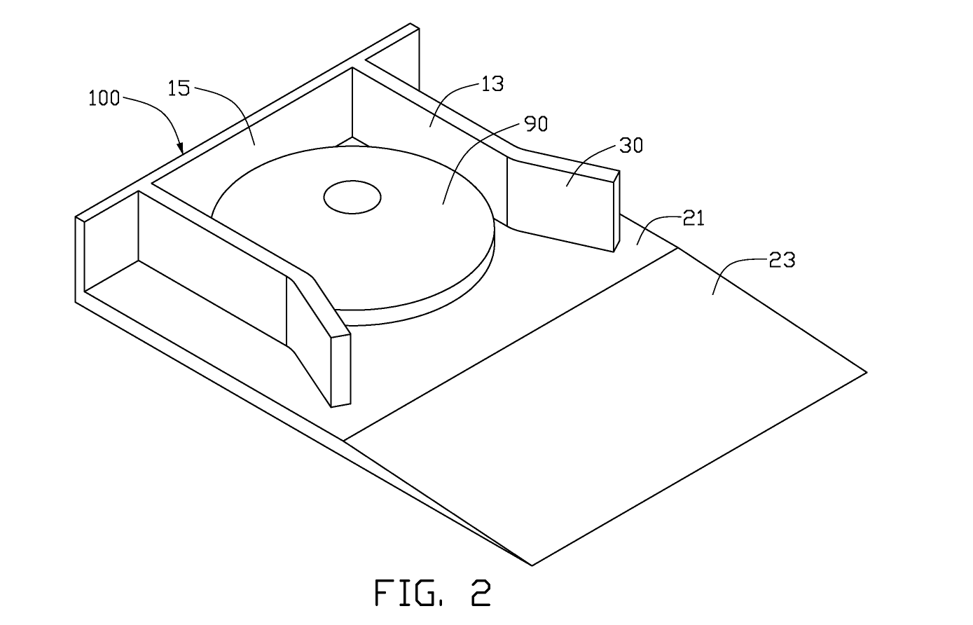

Referring to FIGS. 1 and 2, a charging system 200 in accordance with an exemplary embodiment includes a robot 90 and a charging apparatus 100 detachably connecting with the robot 90 for charging the robot 90.

The robot 90 includes a casing 92, a rechargeable battery 95 installed in the casing 92, and two power receiving terminals 93 electrically connected with the rechargeable battery 95. The casing 92 is substantially flat circular-shaped. The rechargeable battery 95 is used for providing power source for the robot 90. Two opposite slots 91 are defined in the circle of the casing 92. The two power receiving terminals 93 may be metal sheets disposed in the two opposite slots 91 correspondingly.

The charging apparatus 100 includes a base board 20, a stopping portion 15, two opposite charging portions 13, and two guiding walls 30. The charging portions 13 are on opposite sides of the base board 20 and perpendicularly connect with the stopping portion 15 correspondingly. The two guiding walls 30 connect with the charging portions 13 correspondingly.

The base board 20 includes a rectangular-shaped flat portion 21 and an inclined portion 23 obliquely extending from a first edge of the flat portion 21. Therefore, the robot 90 can move on the flat portion 21 from the ground surface (not shown) via the inclined portion 23.

The stopping portion 15 is substantially a wall disposed on a second edge of the flat portion 21 opposite to the first edge. The stopping portion 15 is configured for preventing the robot 90 from overreaching its docking position.

The two charging portions 13 are parallel with each other, and perpendicularly connect with the stopping portion 15 and the flat portion 21. Two power supply terminals 131 are mounted at the two charging portions 13 correspondingly, approximately in the middle of the charging portions 13.

The two power supply terminals 131 may be opposite, and correspond to the two power receiving terminals 93 for connecting a power supply source (not shown) with the power receiving terminals 93. Each of the power supply terminals 131 is arc-shaped, and is bent by a flexible flat sheet, such as metal spring. The power supply terminals 131 may deform when pressed.

The two guiding walls 30 extend from the ends of the charging portions 13 away from the stopping portion 15 to the first edge of the flat portion 21 correspondingly. The distance between the two guiding walls 30 gradually increases from ends of the guiding walls 30 connecting with the charging portions 13, in order for guiding the robot 90 to move towards a position between the two charging portions 13.

While the voltage of the rechargeable battery 95 runs low, the robot 90 may move to the flat portion 21 between the two charging portions 13 via the inclined portion 23. As the robot moves into position between the two charging portions 13, the power supply terminals 131 are pressed by the casing 92 of the robot 90 and deform, prior to alignment with the slots 91. When the two slots 91 are aligned with the power supply terminals 131 correspondingly, the power supply terminals 131 may return to a normal state, thereby, inserting into the slots 91 and contacting with the two power receiving terminals 93, thus, recharging the rechargeable battery 95 of the robot 90. While the power of the rechargeable battery 95 of the robot 90 reaches a predetermined level, the robot 90 may move and press the power supply terminals 131 to deform by the casing 92, therefore, the two power receiving terminals 93 may disconnect with the two power supply terminals 131, the robot 90 may move away from the charging apparatus 100.

The power supply terminals 131 are shaped to be deformable, so that the casing 92 of the robot 90 is prevent from scratches by the power supply terminals 131, and the two power receiving terminals 93 may be protected.

It is to be understood, however, that even though numerous characteristics and advantages of the present disclosure have been set forth in the foregoing description, together with details of the structure and function of the present disclosure, the present disclosure is illustrative only, and changes may be made in detail, especially in matters of shape, size, and arrangement of parts within the principles of the present disclosure to the full extent indicated by the broad general meaning of the terms in which the appended claims are expressed.

What is claimed is:

1. A charging system comprising:
a robot comprising a casing and at least one power receiving terminal, the casing defining at least one slot receiving the at least one power receiving terminal; and
a charging apparatus for charging the robot, the charging apparatus comprising at least one deformable power supply terminal;
wherein the at least one power receiving terminal is pressed to be deformed by the casing of the robot.

2. The charging system as claimed in claim 1, wherein each of the power supply terminal is a flexible flat sheet.

3. The charging system as claimed in claim 2, wherein the power supply terminal is arc-shaped.

4. The charging system as claimed in claim 3, wherein the flexible flat sheet is bent by a metal spring.

5. The charging system as claimed in claim 1, wherein the charging apparatus further comprises two charging portions parallel with each other; and the at least one power receiving terminal is disposed on one of the two charging portions.

6. The charging system as claimed in claim 5, wherein the charging apparatus further comprises a stopping portion perpendicularly connecting with the two charging portions, for preventing the robot from overreaching a charging position.

7. The charging system as claimed in claim 6, wherein the charging apparatus further comprises two guiding walls extending from the two charging portions away from the stopping portion correspondingly.

8. The charging system as claimed in claim 7, wherein the distance between the two guiding walls gradually increases from the ends of the guiding walls connecting with the two charging portions.

9. A charging apparatus for recharging a battery of a robot, comprising:
a charging portion; and
a deformable power supply terminal disposed on the charging portion, the power supply terminal connecting with the battery for recharging the battery of the robot.

10. The charging apparatus as claimed in claim 9, wherein the deformable power supply terminal is arc-shaped.

11. The charging apparatus as claimed in claim 10, wherein the deformable power supply terminal is bent by an elastical flat sheet.

12. The charging apparatus as claimed in claim 11, wherein the deformable power supply terminal is bent by a metal spring.

13. The charging apparatus as claimed in claim 9, further comprising a base board comprising a flat portion and an inclined portion connecting with the flat portion, the charging portion disposed on the flat portion.
